(19) United States
(12) Patent Application Publication
(10) Pub. No.: US 2026/0075385 A1
(43) Pub. Date: Mar. 12, 2026

(54) CONTROL SYSTEM, CONTROL DEVICE, AND METHOD

(71) Applicant: Kabushiki Kaisha Toshiba, Tokyo (JP)

(72) Inventors: Yasuyuki TANAKA, Kawasaki Kanagawa (JP); Hiroki KUDO, Kawasaki Kanagawa (JP)

(73) Assignee: Kabushiki Kaisha Toshiba, Tokyo (JP)

(21) Appl. No.: 19/232,941

(22) Filed: Jun. 10, 2025

(30) Foreign Application Priority Data
Sep. 11, 2024 (JP) 2024-157233

(51) Int. Cl. H04W 4/02; H04W 4/80; H04W 8/22

(52) U.S. Cl. CPC H04W 4/027; H04W 4/80; H04W 8/22

(57) ABSTRACT

A control system includes a terminal to periodically transmit data, and a control device configured to receive the data transmitted from the terminal device. The control device includes first control circuitry configured to control the device to operate when the data is received, and set a time during which the device operates. Further, there is second control circuitry configured to control the device to stop the operation of the device when the data is not received and when the time elapses.

### CROSS-REFERENCE TO RELATED APPLICATION(S)

This application is based upon and claims the benefit of priority from Japanese Patent Application No. 2024-157233, filed Sep. 11, 2024, the entire contents of which are incorporated herein by reference.

### FIELD

Embodiments described herein relate generally to a control system, a control device, and a method.

### BACKGROUND

In general, for the purpose of energy saving or the like, it is known to control a device using a motion sensor capable of detecting a motion of a person, for example.

However, when the motion sensor is used as described above, expected control of the device cannot be performed, and there may be instances where user convenience is low.

### BRIEF DESCRIPTION OF THE DRAWINGS

FIG. 1 is a diagram for explaining an overview of a control system according to a comparative example of an embodiment.

FIG. 2 is a diagram for explaining an overview of a control system according to the present embodiment.

FIG. 3 is a block diagram showing an example of a functional configuration of a terminal device.

FIG. 4 is a diagram showing an example of a hardware configuration of a terminal device.

FIG. 5 is a block diagram showing an example of a functional configuration of a control device.

FIG. 6 is a diagram for explaining a specific aspect of a lighting apparatus.

FIG. 7 is a flowchart showing an example of a processing procedure of the control system.

FIG. 8 is a diagram for explaining an example of a process of registering setting information;

FIG. 9 is a diagram for explaining another example of the process of registering the setting information.

FIG. 10 is a diagram showing an example of a data structure of setting information.

FIG. 11 is a diagram showing an example of a data structure of data transmitted from a terminal device.

### DETAILED DESCRIPTION

In general, according to an embodiment, a control system includes a terminal device configured to periodically transmit data, and a control device configured to receive the data transmitted from the terminal device. The control device includes a first control unit configured to control a device to operate when the data is received, and set a time or duration for which the device operates, and a second control unit configured to control the device to stop the operation of the device when the data is not received until the time or duration for which the device operates elapses after the time or duration for which the device operates is set.

Hereinafter, embodiments will be described with reference to the drawings. In the present embodiment, a control system configured to provide a service for controlling a device will be described, and the device may be implemented as, for example, a lighting apparatus installed in a building or the like.

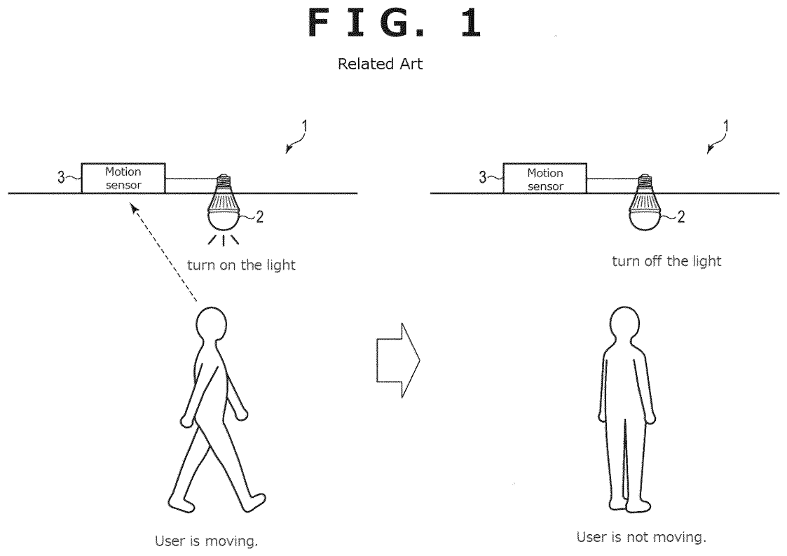

Here, an overview of a control system according to a comparative example of the present embodiment will be described with reference to FIG. 1. In the control system 1 illustrated in FIG. 1, for example, a motion sensor 3 is installed in the vicinity of the lighting apparatus 2, and the motion sensor 3 is connected to the lighting apparatus 2. The motion sensor 3 is configured to detect a motion of a person (that is, a user) in the vicinity of the motion sensor 3 based on, for example, a temperature change due to infrared rays radiated from the person.

According to the control system 1, for example, when the motion of the user is detected by the motion sensor 3, the lighting apparatus 2 can be controlled so that the lighting apparatus 2 is turned on based on the output from the motion sensor 3 (that is, the detection result of the motion of the user). On the other hand, when the motion of the user is not detected by the motion sensor 3, the lighting apparatus 2 can be controlled so as to be turned off.

That is, as described above, the control system 1 using the motion sensor 3 can realize energy saving by providing a service of turning on the lighting apparatus 2 only when a motion of the user is detected.

However, the motion sensor 3 is configured to detect the motion of the user as described above, and cannot detect a user who is not moving. Therefore, in the control system 1 according to the comparative example of the present embodiment, when the user does not move (or the user moves little) in the vicinity of the motion sensor 3 after the lighting apparatus 2 is turned on, the lighting apparatus 2 is turned off even though the user is in the vicinity of the lighting apparatus 2, and the control of the lighting apparatus 2 expected for the control system 1 cannot be realized (that is, lighting control contrary to the expectation is performed in the control system 1).

Therefore, in the comparative example of the present embodiment described above, there are cases where it is not possible to realize lighting control that is highly convenient for the user.

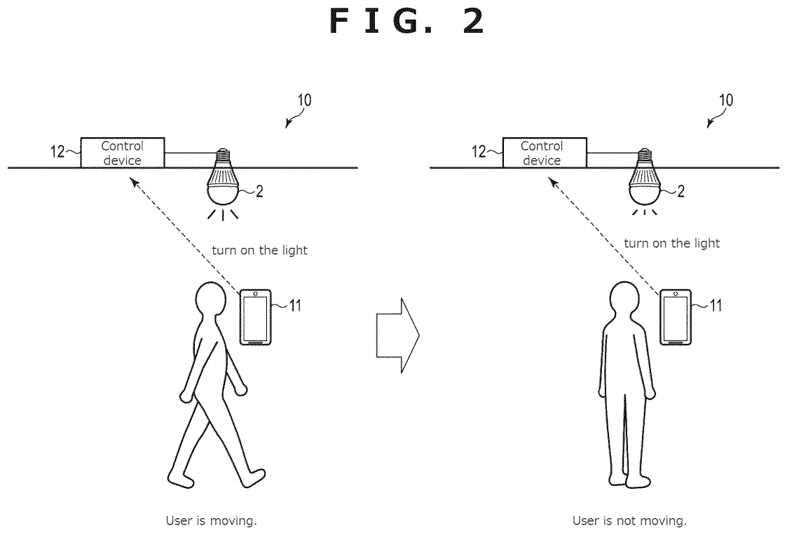

Therefore, in the present embodiment, as illustrated in FIG. 2, a control system 10 that provides a service of controlling the lighting apparatus 2 without depending on the motion sensor 3 described above is proposed.

Although details will be described later, the control system 10 according to the present embodiment includes a terminal device 11 and a control device 12.

The terminal device 11 is, for example, a smartphone or the like carried by a user, and operates to periodically transmit data. The control device 12 corresponds to a communication device having a function of communicating with the terminal device 11, and operates to turn on the lighting apparatus 2 when data periodically transmitted from the terminal device 11 is received.

According to the control system 10 of the present embodiment, for example, regardless of whether or not the user is moving, the lighting of the lighting apparatus 2 can be maintained without turning off the lighting apparatus 2 as long as the control device 12 is in a state where the control device 12 can receive data transmitted from the terminal device 11 carried by the user.

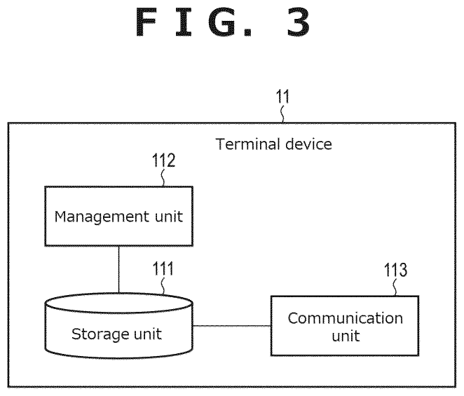

Hereinafter, the control system 10 according to the present embodiment will be described in detail. FIG. 3 is a block diagram illustrated an example of a functional configuration of the terminal device 11 included in the control system 10. As illustrated in FIG. 3, the terminal device 11 includes a storage unit 111 (a memory), a management unit 112 (management circuitry), and a communication unit 113 (communication circuitry).

The storage unit 111 stores setting information related to data transmitted and received between the terminal device 11 and the control device 12. In the setting information stored in the storage unit 111, for example, a bit pattern or the like is set.

The management unit 112 manages the setting information stored in the storage unit 111. The management unit 112 executes processing such as registration, change, and deletion of the setting information stored in the storage unit 111, for example.

The communication unit 113 refers to the setting information stored in the storage unit 111, for example, and periodically transmits data of a bit pattern set in the setting information.

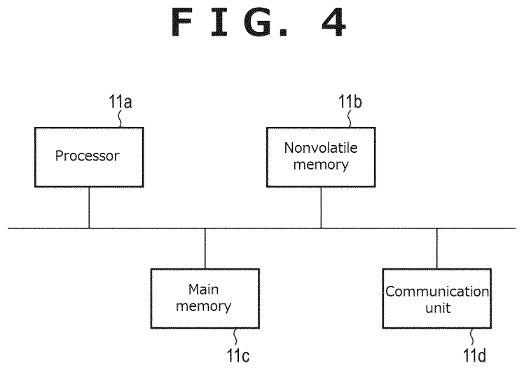

FIG. 4 illustrates an example of a hardware configuration of the terminal device 11. As shown in FIG. 4, the terminal device 11 includes a processor 11a, a nonvolatile memory 11b, a main memory 11c, a communication unit 11d, and the like.

The processor 11a is configured to control operations of components in the terminal device 11, and may be, for example, a CPU. The processor 11a may be a single processor or may be configured by a plurality of processors. The processor 11a executes various programs loaded from the nonvolatile memory 11b to the main memory 11c. The communication unit 11d are devices for realizing communication with the control device 12, for example.

In the present embodiment, the storage unit 111 illustrated in FIG. 3 is implemented by the nonvolatile memory 11b illustrated in FIG. 4, another storage device (not illustrated), or the like.

In the present embodiment, a part or all of the management unit 112 and the communication unit 113 illustrated in FIG. 3 may be realized by causing the processor 11a illustrated in FIG. 4 to execute a predetermined program (that is, software), may be realized by hardware such as an integrated circuit (IC), or may be realized by a configuration in which software and hardware are combined.

Although the terminal device 11 includes the processor 11a, the nonvolatile memory 11b, the main memory 11c, and the communication unit 11d in FIG. 4, the terminal device 11 may further include a touch screen display (a touch panel and a display) or the like if the terminal device 11 is, for example, a smartphone or the like as described above.

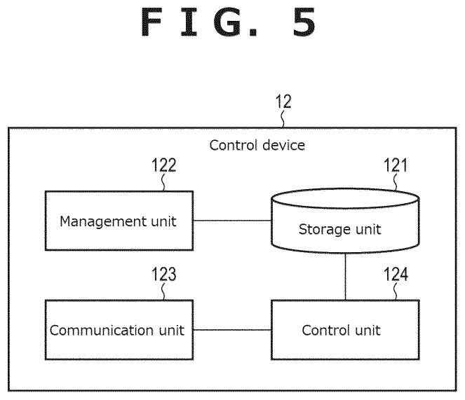

FIG. 5 is a block diagram illustrating an example of a functional configuration of the control device 12 included in the control system 10. As illustrated in FIG. 5, the control device 12 includes a storage unit 121 (memory), a management unit 122 (management circuitry), a communication unit 123 (communication circuitry), and a control unit 124 (communication circuitry).

The storage unit 121 stores setting information related to data transmitted and received between the terminal device 11 and the control device 12. The setting information stored in the storage unit 121 is the same information as the setting information stored in the storage unit 111 included in the terminal device 11 described above.

The management unit 122 manages the setting information stored in the storage unit 121. The management unit 122 executes processing such as registration, change, and deletion of the setting information stored in the storage unit 121, for example.

The communication unit 123 receives data transmitted from the terminal device 11. It is determined whether or not the bit pattern of the data received by the communication unit 123 matches the bit pattern set in the setting information stored in the storage unit 121.

When the communication unit 123 receives data of a bit pattern that matches the bit pattern set in the setting information described above, the control unit 124 controls the lighting apparatus 2 so that the lighting apparatus 2 is turned on (that is, the lighting apparatus 2 operates), and sets a time or duration for which the lighting apparatus 2 is turned on (hereinafter, referred to as a device operation time or a device operation duration).

In addition, when the data (the data of the bit pattern set in the setting information) transmitted from the terminal device 11 is not received during the time from the setting of the device operation time to the elapse of the device operation time as described above, the control unit 124 controls the lighting apparatus 2 such that the lighting apparatus 2 is turned off (that is, the operation of the lighting apparatus 2 is stopped).

Although not shown, the hardware configuration of the control device 12 is substantially the same as that of the terminal device 11 described above, and the control device 12 includes, for example, a processor, a nonvolatile memory, a main memory, a communication device, and the like. In this case, the storage unit 121 illustrated in FIG. 5 is implemented by a nonvolatile memory included in the control device 12, another storage device, or the like. The management unit 122, the communication unit 123, and the control unit 124 illustrated in FIG. 5 may be realized by causing a processor included in the control device 12 to execute a predetermined program (that is, software), may be realized by hardware such as an IC, or may be realized by a configuration in which software and hardware are combined.

In the present embodiment, for example, the control device 12 is provided separately from the lighting apparatus 2, but the control device 12 may be incorporated in the lighting apparatus 2 as a control unit or control circuitry, for example.

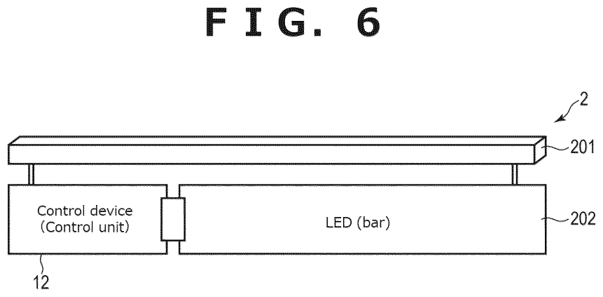

Here, a specific aspect of the lighting apparatus 2 in which the control device 12 is incorporated as a control unit will be described with reference to FIG. 6. In the example shown in FIG. 6, the lighting apparatus 2 includes a lighting apparatus main body 201 and an LED (bar) 202.

Although not shown in FIG. 6, for example, a host controller (not shown) of the lighting apparatus 2 is incorporated in the lighting apparatus main body 201, and the host controller is connected to the control device 12. The host controller of the lighting apparatus 2 and the control device 12 may be connected via a connection interface such as a USB connector or a pin slot connector. The connection of the host controller of the lighting apparatus 2 and the control device 12 in this manner corresponds to providing a communication function to the lighting apparatus 2.

The lighting apparatus main body 201 (host interface) may be connected to, for example, a commercial power supply, and may be configured to supply power to the control device 12 connected to the host interface.

Power is supplied to the LED 202 from the lighting apparatus main body 201. The control device 12 may include actuators for driving the LED 202, and the actuators are connected to the LED 202. According to this, the control device 12 can control the turning on and off of the LED 202. The control device 12 may be configured to adjust the light of the LED 202 via, for example, a dimming I/F.

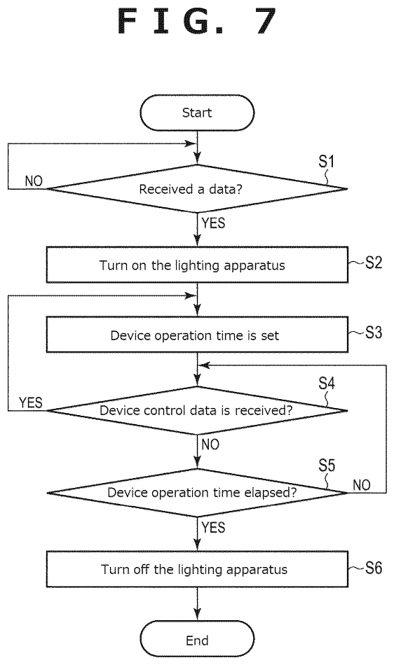

Hereinafter, an example of a processing procedure of the control system 10 according to the present embodiment will be described with reference to the flowchart of FIG. 7. In FIG. 7, the processing of the control device 12 will be mainly described. It is assumed that the lighting apparatus 2 is turned off at the timing when the process of FIG. 7 is started.

First, in the present embodiment, the terminal device 11 and the control device 12 are communicably connected, and, for example, short-range wireless communication is performed between the terminal device 11 and the control device 12. As the short-range wireless communication, wireless communication based on, for example, Bluetooth (registered trademark), Bluetooth Low Energy (hereinafter, referred to as BLE), Wi-Fi (registered trademark), or the like may be utilized.

In the present embodiment, the terminal device 11 (the communication unit 113) is configured to periodically transmit data corresponding to a beacon, for example, and according to the above-described short-range wireless communication, the control device 12 (the communication unit 123) can receive the data transmitted from the terminal device 11 when the user who carries the terminal device 11 is in the vicinity of the control device 12 (that is, the lighting apparatus 2). On the other hand, when the user who carries terminal device 11 is not in the vicinity of control device 12 (that is, lighting apparatus 2), control device 12 (communication unit 123) cannot receive data transmitted from terminal device 11.

The control unit 124 included in the control device 12 determines whether or not the communication unit 123 has received a data for controlling the lighting apparatus 2 (hereinafter, referred to as a device control data) transmitted from the terminal device 11 (step S1).

Here, it is assumed that setting information is stored in the storage unit 111 included in the terminal device 11, and the device control data is data of a bit pattern set in the setting information. In the present embodiment, the bit pattern corresponds to a password set between the terminal device 11 and the control device 12, and as described above, the same setting information as the setting information stored in the storage unit 111 included in the terminal device 11 is stored in the storage unit 121 included in the control device 12.

According to this, the control unit 124 can determine whether or not the data received by the communication unit 123 is the device control data by referring to the setting information stored in the storage unit 121.

That is, for example, even when data is received by the communication unit 123, if the bit pattern of the data received by the communication unit 123 does not match the bit pattern set in the setting information stored in the storage unit 121, it is determined that the device control data is not received by the communication unit 123. When the data is not received by the communication unit 123, it is determined that the device control data is not received by the communication unit 123.

On the other hand, when the bit pattern of the data received by the communication unit 123 matches the bit pattern set in the setting information stored in the storage unit 121, it is determined that the device control data has been received by the communication unit 123.

When it is determined that the device control data is not received by the communication unit 123 (NO in step S1), the process of step S1 is repeated.

On the other hand, when it is determined that the device control data is received by the communication unit 123 (YES in step S1), the control unit 124 controls the lighting apparatus 2 to turn on the lighting apparatus 2 (step S2).

Here, the control unit 124 has a timer, and when the process of step S2 is executed, the above-described device operation time is set in the timer (step S3). When the device operation time has elapsed after the device operation time is set in step S3, the timer operates to notify the elapse of the time. The device operation time set in the timer may be, for example, 10 minutes, but may be another time. The process of step S3 may be, for example, a process of starting a timer in which a device operation time is set.

Next, the control unit 124 determines whether or not additional device control data is received by the communication unit 123 (step S4). The format of this additional device control data may be the same format as the data received in step S1. The process of step S4 is the same as the process of step S1 described above, and thus the detailed description thereof will be omitted here.

When it is determined that the additional device control data is received by the communication unit 123 (YES in step S4), the process returns to step S3 and the process is repeated. In other words, when the device control data is received by the communication unit 123 after the device operation time is set in the timer, a process of resetting the device operation time in the timer (that is, updating the timer and extending the device operation time) is executed.

On the other hand, when it is determined that the device control data is not received by the communication unit 123 (NO in step S4), the control unit 124 determines whether or not the device operation time described above has elapsed (step S5). In step S5, when the timer notifies that the device operation time has elapsed (that is, the timer outputs a signal indicating that the device operation time has elapsed because the timer in which the device operation time is set is expired), it can be determined that the device operation time has elapsed.

When it is determined that the device operation time has not elapsed (NO in step S5), the process returns to step S4 and the process is executed.

On the other hand, when it is determined that the device operation time has elapsed (YES in step S5), the control unit 124 controls the lighting apparatus 2 to turn off the lighting apparatus 2 (step S6).

According to the process illustrated in FIG. 7 described above, when the user carrying the terminal device 11 enters the range in which the short-range communication with the control device 12 can be performed, the lighting apparatus 2 can be controlled so that the lighting apparatus 2 is turned on (that is, the lighting of the lighting apparatus 2 is started). According to the process illustrated in FIG. 7, while the user carrying the terminal device 11 is continuously staying within the range in which the short-range communication with the control device 12 can be performed, the device operation time can be extended so that the lighting of the lighting apparatus 2 is continued. Furthermore, according to the process illustrated in FIG. 7, when the user carrying the terminal device 11 has exited the range in which the short-range communication with the control device 12 can be performed, the lighting apparatus 2 can be controlled so that the lighting apparatus 2 is turned off (that is, the lighting of the lighting apparatus 2 is stopped).

Note that, in FIG. 7, the terminal device 11 and the control device 12 are described as performing communication (short-range wireless communication) based on, for example, Bluetooth or the like, but wireless communication based on, for example, Wi-Fi (registered trademark), LoRa (registered trademark), or the like may be performed between the terminal device 11 and the control device 12, or wireless communication based on other standards may be performed. However, in the present embodiment, since it is necessary to turn on the lighting apparatus 2 when the user who carries the terminal device 11 is in the vicinity of the control device 12, in a case where wireless communication based on, for example, Wi-Fi or the like is performed between the terminal device 11 and the control device 12, the distance between the terminal device 11 and the control device 12 may be estimated based on the signal reception strength of data received by the control device 12, and the lighting apparatus 2 may be turned on when the estimated distance is equal to or less than a predetermined value. Instead of estimating the distance, the signal strength of the data of the terminal device 11 received by the control device 12 may be used, and the lighting apparatus 2 may be turned on when the signal strength is equal to or greater than a predetermined value.

In FIG. 7, since the lighting apparatus 2 can be turned on by the control device 12 receiving data of a bit pattern set in the setting information (that is, device control data), the lighting apparatus 2 cannot be turned on in the control system 10 unless the terminal device 11 has the setting information registered therein (that is, the terminal device 11 has the setting information stored in the storage unit 111), for example. In other words, in the control system 10 according to the present embodiment, it is possible to provide a service of controlling the lighting apparatus 2 only to a specific user who carries the terminal device 11 whose setting information is registered in advance, and to avoid a situation in which the lighting apparatus 2 is turned on by a beacon or the like transmitted from another terminal device.

In the present embodiment, the bit pattern set in the setting information registered in the terminal device 11 may be different for each user who can use the control system 10, or may be common to a plurality of users who can use the control system 10, for example.

Here, as described above, in the present embodiment, it is necessary to register the setting information in the terminal device 11 in advance, but the setting information can be registered (stored) in the terminal device 11 by, for example, downloading an application program (hereinafter, referred to as a device control application) for operating as the terminal device 11 in the control system 10 to the terminal device 11. According to this, by activating an application program in the terminal device 11 and setting a service (function) for controlling the lighting apparatus 2 to be enabled, it is possible to periodically transmit data of a bit pattern set in the setting information from the terminal device 11.

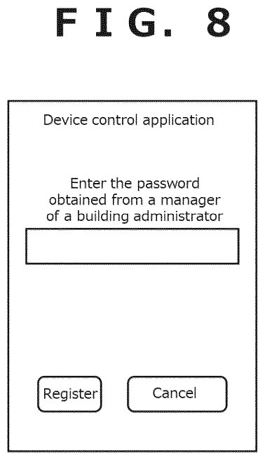

The setting information may be registered in the terminal device 11 by inputting a password obtained from a manager of a building in which the lighting apparatus 2 is installed on a screen as illustrated in FIG. 8 displayed on the terminal device 11 when the device control application is activated (that is, based on an input operation of the user performed on the terminal device 11).

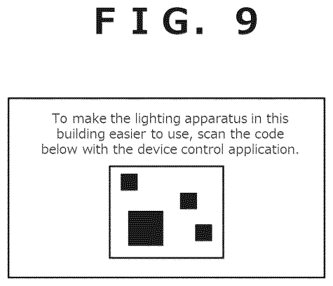

Further, the setting information may be registered by reading a two-dimensional code as illustrated in FIG. 9, which is arranged in a building, by the terminal device 11 that has started the device control application. In this case, the setting information encoded in the two-dimensional code may be registered in the terminal device 11, or the setting information acquired through user authentication or the like after accessing a uniform resource locator (URL) encoded in the two-dimensional code may be registered in the terminal device 11.

Here, the description has been made assuming that the setting information is newly registered in the terminal device 11, but the process of registering the setting information described above may be executed when the setting information (or the bit pattern included in, or the like) is changed or switched.

Here, in the present embodiment, it has been described that the lighting apparatus 2 is controlled (for example, turned on) when the bit pattern of the data transmitted from the terminal device 11 matches the bit pattern set in the setting information stored in the storage unit 121 included in the control device 12 (hereinafter, referred to as setting information of the control device 12), but the content of the control to be performed may be different according to the bit pattern.

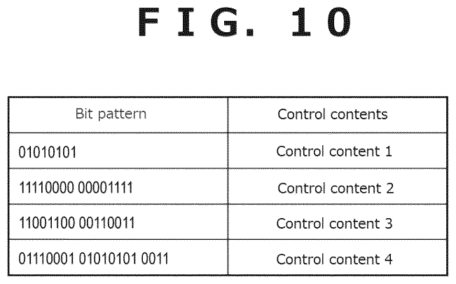

FIG. 10 illustrates an example of the setting information of the control device 12. As illustrated in FIG. 10, the setting information of the control device 12 includes control contents (permission control) in association with each of a plurality of bit patterns. In other words, the setting information is information in which different control contents are set for the respective bit patterns.

In the example illustrated in FIG. 10, for example, in a case where data having a bit pattern of “01010101” is transmitted from the terminal device 11, it is indicated that control of “control content 1” is performed.

In addition, in the example illustrated in FIG. 10, for example, in a case where data having a bit pattern of “11110000 00001111” is transmitted from the terminal device 11, it is indicated that control of “control content 2” is performed.

Furthermore, in the example illustrated in FIG. 10, for example, in a case where data having a bit pattern of “11001100 00110011” is transmitted from the terminal device 11, it is indicated that control of “control content 3” is performed.

In addition, in the example illustrated in FIG. 10, for example, in a case where data having a bit pattern of “01110001 01010101 0011” is transmitted from the terminal device 11, it is indicated that control of “control content 4” is performed.

That is, according to the setting information of the control device 12 as illustrated in FIG. 10, it is possible to perform control of different contents based on data transmitted from the terminal device 11 according to the setting information (that is, bit pattern) registered in the terminal device 11.

Although the setting information illustrated in FIG. 10 has been described as including the bit pattern and the control content in association with each other, the setting information may include, for example, unique data for identifying the terminal device 11, the device control application operating on the terminal device 11, or the user who carries the terminal device 11, instead of the bit pattern. According to such setting information, for example, the unique data is transmitted from the terminal device 11, and thus it is possible to perform control according to the unique data.

The setting information may include the bit pattern, and the unique data described above. In this case, for example, data in which the bit pattern and the unique data are stored (arranged) at different start positions is transmitted from the terminal device 11, and thus it is possible to perform control according to a combination of the bit pattern and the unique data.

In addition, although different control contents are set for each bit pattern in the setting information illustrated in FIG. 10, the control contents may be different in, for example, a time for which the lighting apparatus 2 is turned on (that is, a device operation time) for each bit pattern. The device operation time may be set to, for example, 10 seconds, 60 seconds, 10 minutes, 60 minutes, or the like. In addition, in the control content, for example, the brightness of the lighting apparatus 2 when the lighting apparatus 2 is turned on may be different for each bit pattern.

The setting information in the present embodiment can be said to be information indicating a condition for controlling the lighting apparatus 2, for example, and it is possible to realize controls of the various lighting apparatus 2 by receiving data matching the condition.

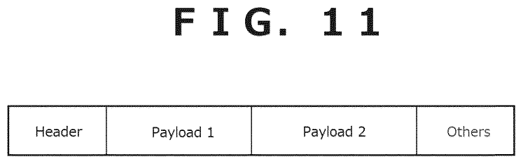

An example of the data structure (packet format) of data transmitted from the terminal device 11 will be described below with reference to FIG. 11. Here, data is transmitted as a beacon of BLE, for example.

As illustrated in FIG. 11, data transmitted from the terminal device 11 includes a header, a payload 1, and a payload 2.

The header stores management information defined by a communication scheme used when the terminal device 11 transmits data. The management information includes, for example, a packet type, address information, and the like.

The payload 1 stores data of the above-described bit pattern. The payload 2 stores the above-described unique data. The unique data corresponds to, for example, data unique to the terminal device 11, data unique to the device control application, or data unique to the user.

Data defined by a communication scheme used when data is transmitted from the terminal device 11, additional data, or the like may be added to the data transmitted from the terminal device 11 as other data.

The data structure illustrated in FIG. 11 is an example, and one of the payload 1 and the payload 2 may be omitted in the data transmitted from the terminal device 11. In addition, in the data transmitted from the terminal device 11, the order of the payload 1 and the payload 2 may be opposite to the data structure illustrated in FIG. 11.

Note that, although the present embodiment has been described assuming that a service for controlling the lighting apparatus 2 is provided only to a specific user by the setting information being registered in the terminal device 11 and the control device 12, a simple configuration in which the setting information is omitted may be adopted as long as the lighting apparatus 2 is controlled when the data transmitted from the terminal device 11 is simply received by the control device 12, for example.

As described above, the control system 10 according to the present embodiment includes the terminal device 11 configured to periodically transmit data and the control device 12 configured to receive the data transmitted from the terminal device 11. In the present embodiment, when the data is received, the control device 12 controls the lighting apparatus 2 so that the lighting apparatus 2 is turned on, and sets a device operation time (a time during which the lighting apparatus 2 is turned on). In addition, when the data is not received during a time from the setting of the device operation time to the elapse of the device operation time, the control device 12 controls the lighting apparatus 2 so that the lighting apparatus 2 is turned off.

In the present embodiment, the above-described configuration makes it possible to improve the convenience of the user.

Specifically, as described in FIG. 1, in the control system 1 using the motion sensor 3, the lighting apparatus 2 is turned off when the user is not moving in the vicinity of the motion sensor 3, whereas, according to the control system 10 according to the present embodiment, as described in FIG. 2, the lighting apparatus 2 can be turned on even when the user is not moving, and thus, it is possible to realize the control of the lighting apparatus 2 expected by the user.

In addition, in the present embodiment, when there is no user in the vicinity of the lighting apparatus 2, the lighting apparatus 2 can be turned off, and thus energy saving related to the control of the lighting apparatus 2 can be realized.

In the present embodiment, the communication performed between the terminal device 11 and the control device 12 may utilize short-range wireless communication based on, for example, Bluetooth or the like. According to such a configuration, since it is not necessary to perform work such as a local area network (LAN) connection or a wide area network (WAN) connection to the lighting apparatus 2 in order to realize the control of the lighting apparatus 2 (that is, to provide a service for controlling the lighting apparatus 2), it is possible to easily realize the control system 10. Furthermore, the present embodiment is advantageous in that the control of the lighting apparatus 2 based on the data transmitted from the terminal device 11 can be performed offline without preparing a server device or the like (that is, without introducing a large-scale communication network).

In addition, in the present embodiment, by the configuration in which the device operation time is set again when data is received before the device operation time elapses, it is possible to continue the lighting of the lighting apparatus 2 stably as long as the user is present in the vicinity of the lighting apparatus 2 (that is, the data is received by the control device 12).

In addition, in the present embodiment, with the configuration in which data of a bit pattern set in advance (that is, device control data) is transmitted and received between the terminal device 11 and the control device 12, for example, it is possible to provide a service of controlling the lighting apparatus 2 to a specific user who carries the terminal device 11 in which setting information in which a bit pattern is set is registered.

Furthermore, in the present embodiment, for example, by referring to setting information including different control contents in association with each of a plurality of bit patterns, the lighting apparatus 2 may be controlled based on the control contents included in the setting information in association with the bit pattern of the received data. According to such a configuration, it is possible to perform appropriate control of the lighting apparatus 2 according to (the bit pattern of) the data transmitted from the terminal device 11.

In the present embodiment, the case where the device controlled by the control system 10 (hereinafter referred to as a control target device) is the lighting apparatus 2 has been mainly described, but the control target device may be a device other than the lighting apparatus 2.

Specifically, the control target device may be a display device (display). In a case where the control target device is a display device, for example, while data transmitted from the terminal device 11 carried by the user is received by the control device 12 due to the user approaching, it is possible to display predetermined information on the display device. The display device in this case may be, for example, a display installed in a vending machine or the like, a display installed for the purpose of displaying an advertisement, or the like.

The control target device may be a sensing device (sensor). In a case where the control target device is a sensing device, for example, while data transmitted from the terminal device 11 carried by the user is received by the control device 12 due to the user approaching, the sensing device can perform sensing (collection, measurement, detection, or the like of data). Note that the data obtained by sensing may be transmitted to the terminal device 11, for example. Such a control system 10 can be used, for example, in a plant equipment patrol.

Further, the control target device may be an actuator. In a case where the control target device is an actuator, for example, the actuator can operate while data transmitted from the terminal device 11 carried by the user is received by the control device 12 due to the user approaching the control target device. The actuator in this case may operate to open and close a door set in a building, for example. The actuator may also operate to drive a player or speaker that plays music or sounds that are broadcast as advertisements, for example in a supermarket or the like.

Here, for example, the control target device in the present embodiment is the lighting apparatus 2, and the lighting apparatus 2 and the control device 12 that controls the lighting apparatus 2 are installed in a rest room in a building. In such a case, it is possible to control the lighting apparatus 2 such that the lighting apparatus 2 is turned on when the user carrying the terminal device 11 enters the toilet and the lighting apparatus 2 is turned off after the user leaves the rest room.

However, the terminal device 11 in such a case may not be carried by the user. Specifically, the terminal device 11 is realized as a tag or the like configured to transmit a beacon, and may be attached to a door of a private room of a restroom, for example. In this case, the terminal device 11 is connected to a sensor capable of detecting opening and closing of a door of a private room of a rest room or a key of the door, for example, and can operate to periodically transmit data when the door or the key of the door is closed.

The terminal device 11 may be attached to a toilet seat, for example. In this case, the terminal device 11 is connected to a sensor capable of detecting opening and closing of a lid of a toilet seat, for example, and can operate to periodically transmit data when the lid of the toilet seat is open. The terminal device 11 may be connected to a sensor capable of detecting whether or not the user is sitting on the toilet seat according to the distortion of the toilet seat, and may operate to periodically transmit data when the user is sitting on the toilet seat.

According to such a configuration, even when the user does not carry the terminal device 11, the lighting apparatus 2 can be turned on when the user is in the rest room, and the lighting apparatus 2 is not turned off even when the user in the rest room moves less.

Note that, as described above, when the control system 10 according to the present embodiment is applied to a rest room, the control target device may be a device configured to play sound during use of the rest room, instead of the lighting apparatus 2.

In the present embodiment, the setting information is registered in the terminal device 11 by downloading the device control application to the terminal device 11, for example. However, the setting information may be registered by another method. Specifically, the setting information may be registered based on an input operation of the user performed on the terminal device 11 after the device control application is activated as described above, or may be registered by reading the two-dimensional code with the terminal device 11.

Further, as described above, when the setting information including different control contents is stored in the storage unit 121 included in the control device 12 in association with each of the plurality of bit patterns, for example, a bit pattern selected from the plurality of bit patterns by a dip switch or the like attached to the terminal device 11 may be registered in the terminal device 11 as the setting information. For example, when a dip switch is attached to the control target device, a bit pattern effective for controlling the control target device may be selected from the plurality of bit patterns by the dip switch.

Note that, in the present embodiment, the control system 10 that provides a service of controlling the control target device without depending on the motion sensor 3 illustrated in FIG. 1 has been described, but the control system 10 may be configured to control the control target device by using both the motion sensor 3 and the control device 12.

Specifically, in the present embodiment, the control target device is controlled so that the control target device operates based on the data periodically transmitted from the terminal device 11, but the control target device may not appropriately operate at the timing when the user approaches the control target device depending on the interval at which the data is transmitted.

In consideration of this point, for example, in a case where the motion of the user is detected by the motion sensor 3 before the data transmitted from the terminal device 11 is received by the control device 12, the control target device may be operated based on the output from the motion sensor 3 (the detection result of the motion sensor 3). However, in order to avoid the operation of the control target device being stopped even though the user is in the vicinity as described above, the operation of the control target device is continued while the data transmitted from the terminal device 11 is received by the control device 12 even when the motion sensor 3 does not detect the motion of the user.

That is, in the configuration in which the motion sensor 3 and the control device 12 are used in combination in the control system 10 according to the present embodiment as described above, priority is given to control based on the output of the motion sensor 3 when the control target device is operated, and priority is given to control based on the data transmitted from the terminal device 11 when the operation of the control target device is stopped.

For example, in a case where the terminal device 11 is a smartphone or the like, when the user leaves the terminal device 11 in the vicinity of the control target device, a situation in which the control target device continues to operate even though the user is not in the vicinity of the control target device may occur. Therefore, for example, in a case where a time in which the control device 12 continues to receive the data transmitted from the terminal device 11 exceeds a predetermined time, the control based on the output of the motion sensor 3 may be prioritized over the control based on the data transmitted from the terminal device 11, and the operation of the control target device may be stopped.

The time in which the control based on the output of the motion sensor 3 is prioritized and the time in which the control based on the data transmitted from the terminal device 11 is prioritized (that is, the priority for each control) may be set in the setting information of the control device 12, for example.

Although the present embodiment has been described mainly on the assumption that the control device 12 and the control target device (for example, the lighting apparatus 2) are separately configured, the control device 12 may be incorporated in the control target device as described above with reference to FIG. 6. Only a part of the control device 12 may be incorporated in the control target device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention, and are also included in the invention described in the claims and the scope of equivalents thereof.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The disclosure includes a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

What is claimed is:

1. A control system comprising:
a terminal including communication circuitry to periodically transmit data, and
control circuitry including:
communication circuitry to communicate with the communication circuitry of the terminal;
first control circuitry configured to, when the data from the terminal is received, start operation of a device and start a timer; and
second control circuitry configured to stop operation of the device when additional data is not received from the terminal after the timer is started, and a duration of the timer elapses.

2. The control system according to claim 1, wherein:
the communication performed between the communication circuitry of the terminal and the communication circuitry of the control circuitry includes short-range wireless communication.

3. The control system according to claim 1, wherein:
the first control circuitry resets the timer when the additional data is received after the operation of the device is started.

4. The control system according to claim 1, wherein:
the data and the additional data are a same preset bit pattern.

5. The control system according to claim 4, wherein:
the control circuitry includes a memory that stores setting information including different control contents in association with each of a plurality of bit patterns, and
the first control circuitry controls the device based on control content included in the setting information in association with a bit pattern of the received data.

6. The control system according to claim 1, wherein:
the device includes a light, a display, a sensor, or an actuator.

7. The control system according to claim 1, wherein:
the first control circuitry controls the device so that the device is turned on based on an output from a motion sensor.

8. A controller, comprising:
communication circuitry configured to communicate with a terminal which periodically transmits data;
first control circuitry configured to, when the data from the terminal is received, start operation of a device and start a timer; and
second control circuitry configured to stop operation of the device when additional data is not received from the terminal after the timer is started, and a duration of the timer elapses.

9. The controller according to claim 8, wherein:
the communication circuitry communicates using short-range wireless communication.

10. The controller according to claim 8, wherein:
the first control circuitry resets the timer when the additional data is received after the operation of the device is started.

11. The controller according to claim 8, wherein:
the data and the additional data are a same preset bit pattern.

12. The controller according to claim 11, further comprising:
a memory that stores setting information including different control contents in association with each of a plurality of bit patterns,
wherein the first control circuitry controls the device based on control content included in the setting information in association with a bit pattern of the received data.

13. The controller according to claim 8, wherein:
the device includes a light, a display, a sensor, or an actuator.

14. The controller according to claim 8, wherein:
the first control circuitry controls the device so that the device operates based on an output from a motion sensor.

15. A method, comprising:
receiving data;
controlling a device so that the device operates when the data is received;
starting a timer in response to the received data;
stopping the operation of the device when additional data is not received after the timer is started, and a duration of the timer elapses.

16. The method according to claim 15, further comprising:
receiving a signal from a motion detector; and
initially operating the device in response to the signal from the motion detector.

17. The method according to claim 16, wherein:
the signal from the motion detector is received before the receiving of the data.

18. The method according to claim 15, further comprising:
receiving the additional data; and
resetting the timer in response to the receiving of the additional data.

19. The method according to claim 18, wherein:
the data and the additional data are a same bit pattern.

20. The method according to claim 15, wherein:
the device is light.
